(19) United States
(12) Patent Application Publication
(10) Pub. No.: US 2026/0321452 A1
(43) Pub. Date: Oct. 15, 2026

(54) SYSTEM AND METHOD FOR COOLING A COULOMB CRYSTAL

(71) Applicant: Oxford Ionics Limited, Begbroke (GB)

(72) Inventor: Robert Tyler Sutherland, Austin (GB)

(21) Appl. No.: 19/175,337

(22) Filed: Apr. 10, 2025

(51) Int. Cl. G21K 1/00

(52) U.S. Cl. CPC G21K 1/00

(57) ABSTRACT

A method of cooling a Coulomb crystal is presented. The Coulomb crystal has a first ion and a second ion having different masses. An electric field is applied to the Coulomb crystal to couple a first motional mode and a second motional mode of the Coulomb crystal. The electric field is adjusted to put the first motional mode and the second motional mode in an avoided crossing. The Coulomb crystal is then cooled while the first motional mode and the second motional mode are in the avoided crossing.

### TECHNICAL FIELD

The present disclosure relates to a system and method for cooling a Coulomb crystal.

### BACKGROUND

Quantum circuits are made of many quantum logic gates also referred to as quantum gates or simply gates. During gate operations, certain sources of errors increase proportionally with temperature—particularly two qubit gates. The error due to non-linearities in the Coulomb potential, for example, scales quadratically with nbar (the average number of phonons in the experiment, averaged over many iterations). Cooling the ions permits to reduce or suppress the infidelities due to such errors.

A quantum charge-coupled device (QCCD) architecture typically needs a coolant ion to remove heat from the system without using any control field frequencies near any transitions of the qubit. One approach referred to as OMG (optical, metastable and ground state) uses different manifolds of the same ion for gating/cooling. Metastable states are D states and have a lifetime of ~10 s. Ground states are S states and have much longer lifetimes. A transition between S and D states is referred to as an ‘optical transition’ due to the wavelength of laser light required to induce this transition. An optical qubit means the qubit has one state in the S ground manifold and one state in the D manifold i.e. it has an optical qubit transition frequency.

A metastable qubit means the qubit has two states in the D5/2 manifold. A ground state qubit has both states in the S1/2 ground state. One of the primary advantages of the OMG scheme is that one can perform sympathetic cooling on two ions of a same species by using a D5/2 metastable qubit for the whole circuit. This manifold is chosen because the P1/2 manifold cannot population leak into it. It is therefore possible to bring a coolant ion of the same species next to the metastable qubit and drive the S-P transition to sympathetically cool the two ion crystal without disturbing the information stored in the metastable qubit.

The main limitations with the D5/2 manifold are that it has spontaneous emission, where it leaks to the S1/2 manifold. Also, it has many spectator states in a narrow bandwidth, which makes it a lot more vulnerable to stray fields and more difficult to perform high-fidelity gates on.

One of the disadvantages of using a different species ion is that the radial modes of mixed-species crystals “decouple”, and each mode is almost all coolant or all qubit. For two ion crystals, “mostly qubit” modes often cool several orders of magnitude slower than “mostly coolant” modes.

Various schemes have been proposed to exchange heat between slow cooling modes and fast cooling modes, using the ‘fast cooling’ modes as a heat sink (See: Phys. Rev. A 89, 062332 (2014); Phys. Rev. Lett. 119, 193602 (2017); arXiv preprint arXiv:2205.14841 (2022); Phys. Rev. X 14, 041046 (2024)). These schemes rely on inducing a transition between the two modes with a high transfer probability. This requires implementing an operation to exchange the modes and controlling the coupling precisely. In addition, such schemes are limited by the efficiency of that transition itself.

It has also been reported that in the presence of strong radial electric fields, certain trapping potentials exist where the slow cooling “mostly qubit” modes begin to cool more efficiently (See: Adv. At. Mol. Opt. Phys. 62, 231 (2013); Hume, D., 2010. Two species ion chains for quantum logic spectroscopy and entanglement generation. Ph.D. thesis, Chapter 4). However, these studies are limited to specific mixed species ion pairs and do not provide a systematic method for achieving efficient cooling—outside of scanning the trap parameters and empirically noting the points where it occurs

It is an object of the disclosure to address one or more of the above mentioned limitations.

### SUMMARY

According to a first aspect of the disclosure, there is provided a method of cooling a Coulomb crystal, the Coulomb crystal comprising a first ion and a second ion having different masses, the method comprising:
applying an electric field to the Coulomb crystal to couple a first motional mode and a second motional mode of the Coulomb crystal;
adjusting the electric field to put the first motional mode and the second motional mode in an avoided crossing; and
cooling the Coulomb crystal while the first motional mode and the second motional mode are in the avoided crossing.

Optionally, wherein the first motional mode has a first motional frequency and the second motional mode has a second motional frequency, and wherein the step of adjusting the electric field is performed at a rate that is slower than a frequency difference between the first motional frequency and the second motional frequency.

Optionally, wherein in the avoided crossing the first motional mode and the second motional mode are adiabatically mixed.

For instance, the first motional mode and the second motional mode may exchange character.

Optionally, cooling the Coulomb crystal in the avoided crossing does not induce a transition between the first motional mode and the second motional mode.

Optionally, wherein when cooling the Coulomb crystal in the avoided crossing, the first motional mode and the second motional mode cool down at substantially the same rate.

For instance, the first mode may be a fast-cooling mode and the second mode a slow-cooling mode, but when the Coulomb crystal is in the avoided crossing the first and second mode cool down at a same rate or substantially same rate.

For instance, the rate may be about half as fast as the fast-cooling mode.

Optionally, the electric field is a radial electric field.

Optionally, wherein the first motional mode is an axial mode, and the second motional mode is a radial mode.

Optionally, wherein the first ion and the second ion are selected from different ion species to form a mixed-species Coulomb crystal.

For instance, the Coulomb crystal may be a Ba—Ca crystal, or a Ba—Sr crystal or a Ba—Yb crystal, to name a few.

Optionally, the first ion is a coolant ion for cooling the Coulomb crystal, and the second ion is a qubit ion for forming a qubit.

Optionally, the coolant ion is heavier than the qubit ion.

Optionally, the step of cooling the Coulomb crystal is performed using a laser cooling technique.

Optionally, the method further comprises: performing a spectroscopy measurement to check that the Coulomb crystal is in the avoided crossing.

According to a second aspect of the disclosure, there is provided an ion trap system comprising an ion trap coupled to a controller configured to perform the method of the first aspect.

For instance the ion trap may be a paul trap.

Optionally, the ion trap comprises a plurality of DC electrodes and at least one drive electrode, the ion trap system further comprising a voltage source coupled to the DC electrodes; a signal generator coupled to the said at least one drive electrode; wherein the controller is configured to vary the voltage at the DC electrodes to apply and adjust the electric field.

Optionally, the ion trap system further comprises a laser system and a photon detector, and where in the controller is configured to control the laser system to perform a laser cooling technique.

According to a third aspect of the disclosure, there is provided a quantum device comprising the ion trap system according to the second aspect.

For instance the quantum device may comprise a plurality of ion traps. The quantum device may be a quantum computer.

### DESCRIPTION OF THE DRAWINGS

The disclosure is described in further detail below by way of example and with reference to the accompanying drawings, in which:

FIG. 1 is a flow chart of a method for cooling a Coulomb crystal according to the disclosure;

FIG. 2 is a schematic diagram of an ion trap system for implementing the method of FIG. 1;

FIG. 3A is an exemplary implementation of the ion trap system of FIG. 2;

FIG. 3B is a diagram of the ion trap used in the system of FIG. 3A;

FIG. 4 is a plot showing the frequency of six motional modes of a Ba—Ca Coulomb crystal as a function of the axial frequency of the Ba ion;

FIG. 5 is a plot showing the fractional participation of the Ca ion as a function of frequency for three different modes shown in FIG. 4;

FIG. 6 is a plot showing the frequency of six motional modes of a Ba—Ca Coulomb crystal as a function of the axial frequency of the Ba ion, with the radial electric field being turned off;

FIG. 7 is a plot showing the frequency of six motional modes of a Ba—Sr Coulomb crystal as a function of the axial frequency of the Ba ion.

### DESCRIPTION

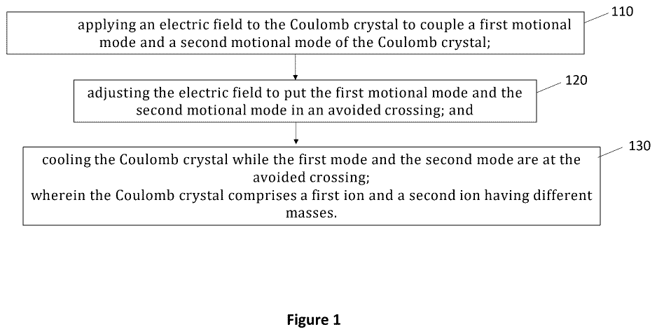

FIG. 1 is a flow chart of a method for cooling a Coulomb crystal comprising a first ion and a second ion having different masses. A Coulomb crystal is formed of trapped ions confined in a crystal-like structure at low temperature. In the crystal there is an equilibrium between the repulsive Coulomb interaction between ions and the electric and magnetic fields used to confine the ions. The first ion may be a coolant ion for cooling the Coulomb crystal, and the second ion may be a qubit ion for forming a qubit. The method includes the following steps:

At step 110, an electric field is applied to the Coulomb crystal to couple a first motional mode and a second motional mode of the Coulomb crystal. At step 120, the electric field is adjusted to put the first motional mode and the second motional mode in an avoided crossing. The step of adjusting the electric field is performed at a rate that is slower than a frequency difference between the first motional frequency of the first mode and the second motional frequency of the second mode in order to maintain adiabaticity.

At step 130 the Coulomb crystal is cooled while the first motional mode and the second motional mode are in the avoided crossing. For instance, cooling the Coulomb crystal may be performed using a laser cooling technique. The electric field is maintained (hence applied to the Coulomb crystal) during the cooling.

An avoided crossing occurs when the eigenvalues of two eigenmodes or eigenvectors pass through degeneracy. If there is a coupling between the two states, the eigenvalues will not “cross” but instead push each other apart making the so called “avoided crossing”. When this happens, the two (or more) modes that undergo the crossing exchange character, becoming mixtures of one another. Therefore, if one slowly passes through such a crossing then turn off the coupling it effectively drives a transition since the two motional states do not change. This is often referred to as a Landau-Zener crossing as they were the first to derive an analytic equation describing this type of transition.

The method of FIG. 1, does not rely on a transition, and thus has relaxed constraints on how precise the control fields need to be to achieve efficient cooling. There is also no efficiency lost from not knowing the exact coupling between the two modes, as the method only requires for the modes to be coupled. This is not true for prior techniques that do use Landau-Zener transitions, as is the case in Phys. Rev. X 14, 041046 (2024).

The method may be applied to ions of different species, forming a mixed species ion crystal. Examples of mixed ions crystals include, without limitation: Calcium-Barium (Ca—Ba) crystal, Barium-Strontium (Ba—Sr) crystal, Barium-Ytterbium (Ba—Yb), among others.

Different mass ratios could be considered. For instance the masse ratio between the pair of ions may be selected to be in the region of 3:1, or less. The method of FIG. 1, could also be extended to more than two ions.

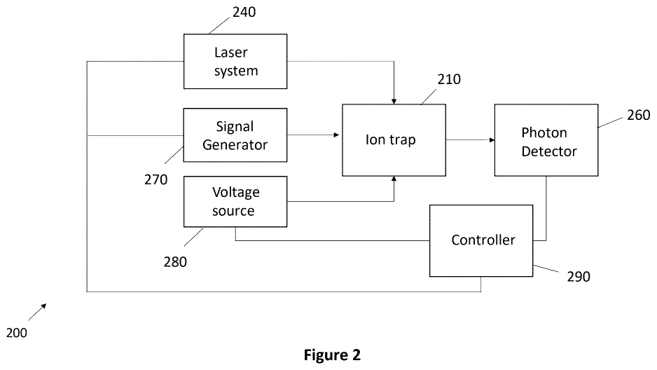

FIG. 2 is a schematic diagram of an ion trap system for implementing the method of FIG. 1. The ion trap system 200 may be used to implement different types of traps such as a Paul trap that would use an RF drive signal for trapping the ions making the Coulomb crystal or a Penning trap that would use a magnetic field for trapping the ions and for which no RF drive is required. The ion trap system 200 includes an ion trap 210, a laser system 240, a signal generator 270, a voltage source 280 and a photon detector 260. A controller 290 is provided to control the laser system 240, the signal generator 270, the voltage source 280 and the detector 260. The controller 290 is configured to perform the method as described in FIG. 1. Optionally, a source of magnetic field 250 may also be provided. The magnetic field source 250 can be used to set the frequency of internal transitions of the ion. Optionally, the magnetic field source may also be used to trap ions (i.e. a Penning trap).

The laser system 240 may include several lasers. The number and type of lasers depends on the ion species in use, and the application. For instance, a first laser may be required to drive the ion into a metastable state, and a second laser for exciting fluorescence.

When using a Penning trap, the signal generator 270 may be used to provide a drive signal to couple motional modes. When using a Paul trap, the signal generator 270 would be used to create a drive signal for trapping the ion(s).

The signal generator 270 may be an RF generator configured to generate an electrical signal received by a pair of RF electrodes.

The voltage source 280 may include several sub generators having specific connections to electrodes of the ion trap. The electrodes may be adjusted over time to achieve the desired Electric field. For adiabatic control fields the electrodes may be adjusted over hundreds of microseconds.

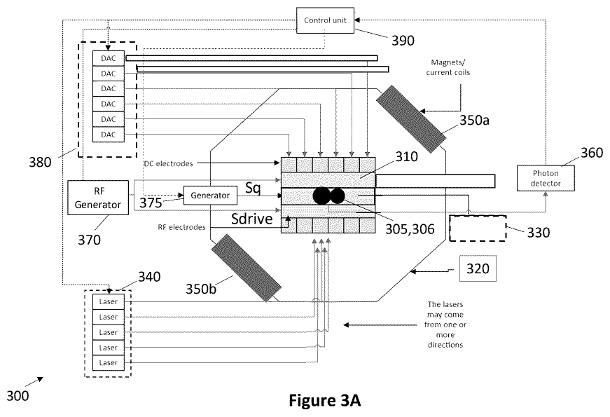

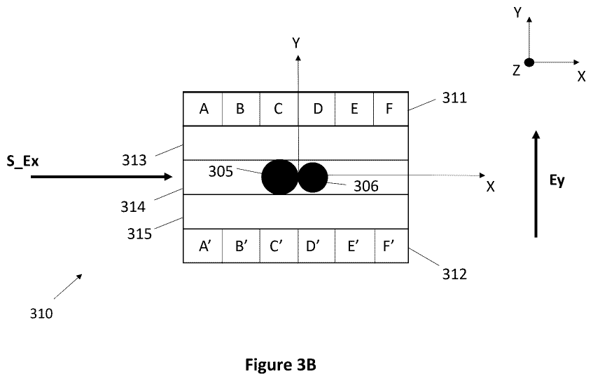

FIG. 3A is an exemplary implementation of the ion trap system of FIG. 2. The trapped ion system 300 includes an ion trap 310 provided in a vacuum chamber 320. The ion trap 310 is coupled to an ion source 330, configured to provide the ions 305 and 306 to the ion trap. The trapped ion system 300 also includes a laser system 340; a magnetic field source 350a, 350b; a fluorescence detector 360, an RF generator 370, a voltage source 380, and a controller 390. Optionally, another signal generator 375 may be provided to perform quantum operations. For instance, the generator 375 may provide a signal Sq for the electrode 314. The magnetic field source 350 is optional and may be used to apply a magnetic field to the ion trap. The magnetic field source 350a and 350b could be, for example, a pair of coils. The laser system 340 may be used to perform various functions including: laser cooling, spectroscopy readout, and optionally qubit manipulation.

The laser and detection system may be used to verify that the Coulomb crystal is in an avoided crossing. For instance, considering an ion having two states, 0 and 1, the system may be initialized to the 0 state. Then one can apply a laser (or microwave) at the transition frequency of 0→1 plus a given frequency (~MHz). When the applied field equals the transition frequency PLUS the frequency of a motional mode the ion will transition from 0 to 1. When a laser interaction is applied that causes the ion to fluoresce if and only if it is in 1. By scanning the frequency of the first transition and determining when the overall process that causes the ion to ‘glow’ on the sensor, one can back out the motional mode frequencies for any trap potential.

FIG. 3B is a diagram of the ion trap 310 used in the system of FIG. 3A. The ion trap 310 includes three types of electrodes: DC electrodes coupled to the voltage source 380, RF electrodes coupled to the RF generator 370 for trapping the ion, and an RF or a microwave electrode coupled to the generator 375 for performing quantum operations.

In this example the ion trap 310 has two sets of outer DC electrodes labelled 311 and 312, and two RF electrodes labelled 313 and 315. An additional electrode 314, also referred to as antenna, may be provided between the RF electrodes 313, 315. The electrode 314 is designed to carry microwave currents in order to perform quantum gates (see FIG. 3B). Each set of DC electrodes includes 6 DC electrodes labelled ABCDEF and A′B′C′D′E′F′, respectively. The RF electrodes 313 and 315 and the microwave electrode 314 have a longitudinal shape and are arranged side by side. The RF electrodes are sandwiched between the two sets of outer DC electrodes 311 and 312. The number of electrodes and the electrode configurations may vary. The number of RF electrodes may also be increased.

The RF electrodes are used to confine the ions 305, 306 in the yz plane as shown in FIG. 3B. In the trap shown in FIG. 3B the ions 305 and 306 forming the Coulomb crystal are confined in the y- and z-dimensions by the RF field.

The ion source 330 includes a neutral atom source to provide the neutral atom and an ionisation device configured to ionize the atom and hence provide the ions 305 and 306. The neutral atom source and ionisation device are not shown in the FIG. 3A. The neutral atom source could be, for example, a resistively heated atomic oven or an ablation target. The ionisation device could be, for example, a network of lasers of various operational wavelengths.

The Coulomb crystal may be cooled down to the Doppler temperature or in the ground state of all its motional modes. This can be achieved using the laser system 340 by performing various laser cooling techniques. As such the controller 390 may be configured to control the laser system 340 for implementing various laser cooling techniques.

The controller 390 is configured to vary the voltage at the DC electrodes 311, 312 to apply and adjust the electric field applied to the Coulomb crystal. For instance, different voltages may be applied at the electrodes A, B, C, D, E, F of 311. Similarly different voltages may be applied at the electrodes A′, B′, C′, D′, E′, F′ of 312.

In the present example the ion 305 is located between the electrodes C and C′, while the ion 306 is located between the electrodes D and D′. A radial electric field Ey can be applied on the Coulomb crystal 305, 306 using the electrode C, D and C′, D′. The controller 390 may be configured to control the voltage source 380 to obtain the desired electric field.

The modes are coupled together with a radial electric field. As the two ions are radially confined in different potentials, each potential inversely proportion to the ions mass 1/m, applying the same force to both ions will “push” them to different radial distances. When this happens, the crystal twists into a radial direction and the Coulomb force couples the axial and corresponding radial modes. This coupling mechanism has been discussed in Phys. Rev. X 14, 041046 (2024) titled “Cooling trapped ions with phonon rapid adiabatic passage”.

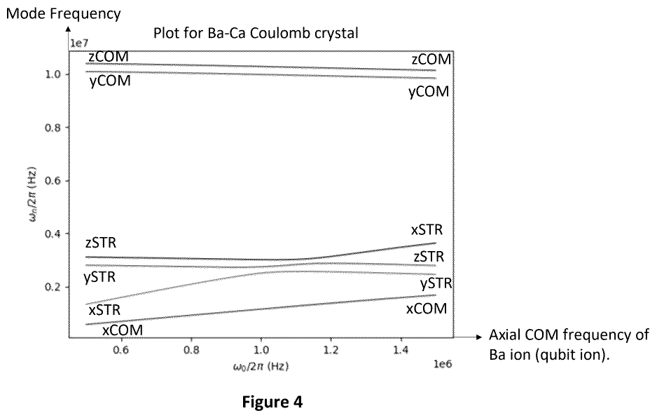

FIG. 4 is a plot showing the frequency of six motional modes of a Ba—Ca Coulomb crystal as a function of the axial frequency of the Ba ion. The plot of FIG. 4 is obtained when applying a radial electric field Ey of 400 V/m to a Calcium-Barium (Ca—Ba) crystal and increasing the axial confinement of the trap. Six modes are represented, that include three stretch (STR) modes: xSTR, ySTR, zSTR; and three the center of mass (COM) modes: xCOM, yCOM, zCOM, where x=axis of trap, y=axis out of trap and z=axis not in these two directions.

In COM mode the two ions of the Coulomb crystal (here the Ba and Ca ions) oscillate in phase with each other. In the STR mode the two ions oscillate out of phase with each other. The vertical axis of the plot shows the frequency of each mode. The horizontal axis of the plot is the single ion axial COM frequency of the Ba ion. In other words, the horizontal axis is the axial confinement which is quantified by the axial frequency of a single trapped Ba ion. This is almost identical to the xCOM frequency.

Applying a radial E-field to a mixed-species Coulomb crystal moves the two ions by different amounts. This is due to the 1/m (m=mass of the ion) dependence of the pseudopotential in a Paul trap. When this occurs, the Coulomb potential couples the axial and radial modes. If, in addition to this coupling, the crystal is adjusted until the modes approach degeneracy, then the eigenvalues of the modes will go through a so called avoided crossing.

In FIG. 4, the avoided crossing is obtained around 1.1 MHz between the xSTR, ySTR modes and the zSTR mode. Mode labels are shown before and after the avoided crossing. The avoided crossing can be identified by the large frequency gap (on the vertical axis) between the zSTR line in the one hand and the xSTR and ySTR lines on the other hand. Usually, the ySTR and zSTR modes cool relatively slowly, since they are mostly Ba (the assumed qubit). When these three modes experience an avoided crossing, they become complicated mixtures of one another. It does not matter how much of each mode is mixed in, as long as the xSTR mode is mixing in with the ySTR and zSTR modes, this will mix the coolant ion into both modes, hence allowing the cooling of both the coolant ion and the qubit ion.

The xSTR mode is an axial mode, which do not experience a “decoupling effect”. The axial confinement is a DC potential. The radial potential for a Paul trap is 1/m, unlike the axial potential, which is what causes the decoupling when m is not the same for both ions.

The spacing of the avoided crossing dictates the adiabatic condition for the quantum gate. Passing through the avoided crossing over a timescale that is slow relative to the size of the crossing would maintain adiabaticity. If the coupling is then turned off to return to the initial state of the crystal, the “exchange” will not happen on the way back and a transition could occur.

In FIG. 4, Ca is the coolant ion, and Ba is the qubit ion. Whilst the frequency of each mode affects its cooling rate, the cooling rate of a mode depends primarily on how much coolant ion is present in the mode. Ions of different masses will result in the modes being mostly one ion or the other. The greater the amount (or fraction) of coolant ion in the mode, the faster the cooling rate of the mode. Conversely, the lower the fraction of coolant ion, the slower the cooling rate of the mode.

The radial rSTR modes (which are mostly Ba in this example) will be difficult to cool down. Here the “r” stands for radial and could be either the y or the z axis (ySTR and zSTR modes). The radial modes behave differently than the axial modes (along the x axis). As the radial confinement is proportional to 1/m, it is thus different for each ion. Since each ion is radially confined by a different potential, this makes it more difficult for the ions to resonantly interact with each other. Due to the radial confinement, the radial modes have less coolant ions, hence making it more difficult to cool them down. This means that cooling these radial modes, for instance ySTR and zSTR in FIG. 4, would take more time. In contrast the axial modes have reasonable amounts of both ions.

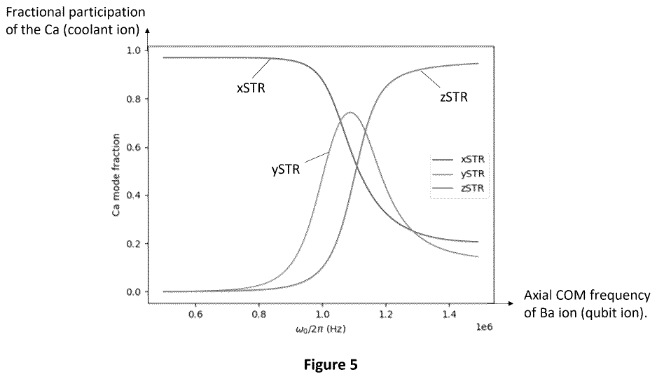

FIG. 5 is a plot showing the fractional participation of the Ca ion as a function of frequency for three different modes shown in FIG. 4. FIG. 5 illustrates the modal structure during the avoided crossing of FIG. 4. The vertical axis is the fractional participation of the coolant ion (Ca40) in the STR modes xSTR, ySTR and zSTR. The horizontal axis is the single ion axial COM frequency of the Ba ion, like in FIG. 4.

At low frequencies the xSTR mode is mostly coolant ion whilst the ySTR and zSTR (rSTR modes) are mostly qubit and will therefore cool more slowly. When going through the avoided crossing, the character of all three modes changes such that they are all roughly half coolant ion. In this frequency region, the three modes can be cooled relatively quickly.

During the avoided crossing, each mode is approximately half Ca, meaning the modes could be cooled substantially at the same time. Since each mode is being mixed with xSTR, they all have a projection onto the axis of the trap, allowing to cool all three modes with axially projected light. So, by slowly adjusting the potential of the trap until it is approximately at the avoided crossing point, and then cooling all three modes that are being crossed, it is possible to improve the speed and efficiency at which these modes can be cooled down.

Although an example is provided for a Ba-Ca Coulomb crystal, it will be appreciated that this approach can be extended to other Coulomb crystals made of different types of ions. The method presented in FIG. 1 can be applied as long as the Coulomb crystal remains stable through the avoided crossing. For crystals with large mass ratios, the Coulomb crystal becomes unstable before either rCOM mode crosses xSTR (See: Adv. At. Mol. Opt. Phys. 62, 231 (2013); Hume, D., 2010. Two species ion chains for quantum logic spectroscopy and entanglement generation. Ph.D. thesis, Chapter 4).

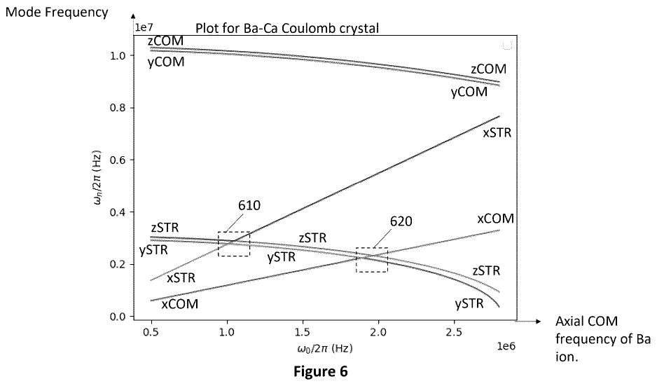

FIG. 6 is a plot showing the frequency of six motional modes of a Ba—Ca Coulomb crystal as a function of the axial frequency of the Ba ion, shown over an extended frequency range with the radial electric field being turned off. The radial modes ySTR and zSTR decrease to zero before the axial mode xSTR crosses either rCOM modes, reaching the ‘zig-zag’ instability, before rCOM begins to efficiently cool. Such limitations can be avoided for crystals having a mass ratio closer to one. For example, a Barium-Strontium (Ba—Sr) crystal has a mass ratio 137/88~1.6.

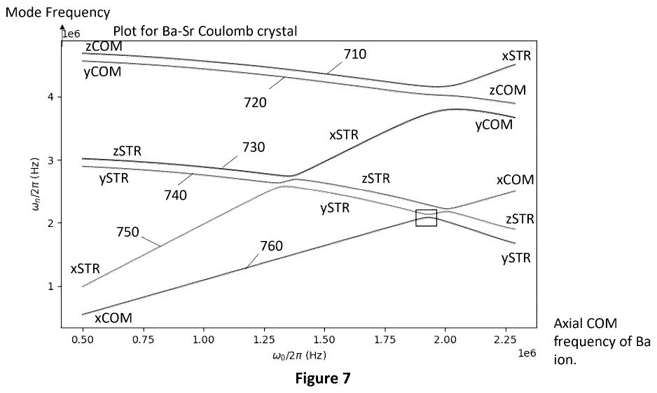

FIG. 7 is a plot showing the frequency of six motional modes of a Ba—Sr Coulomb crystal as a function of the axial frequency of the Ba ion. The plot of FIG. 7 is obtained when applying a radial electric field Ey~Ez~100 V/m to a Ba—Sr crystal and increasing the axial confinement of the trap.

A first avoided crossing occurs around 1.3 MHz and a second avoided crossing around 2 MHz. The labels show the mode before and after avoided crossing. Six waveforms are represented labelled 710, 720, 730, 740, 750 and 760. Waveform 710 starts as the zCOM mode and remains zCOM. Waveform 720 starts as the yCOM mode and then swaps to become zCOM mode around 2 MHz. Waveform 730 starts as the zSTR mode and then swaps to become xSTR mode around 1.3 MHz, and then yCOM mode around 2 MHz. Waveform 740 starts as the ySTR mode and then swaps to become zSTR mode around 1.3 MHz. Waveform 750 starts as the xSTR mode and then swaps to become yCOM mode around 2 MHz. Waveform 760 starts as the xCOM mode and then swaps to become ySTR mode around 2 MHz.

The rCOM modes (yCOM, zCOM) undergo an avoided crossing with xSTR well before the rSTR modes fall to zero and the crystal gets close to its zig-zag instability. So, for a Ba—Sr Coulomb crystal, one can cool both rCOM and rSTR using the method of FIG. 1. Other crystals display this behaviour, such as the Barium-Ytterbium (Ba—Yb) crystals used Phys. Rev. X 14, 041046 (2024).

The method of the disclosure permits cooling the radial COM modes while staying far away from points of crystal instability. The ability to cool radial COM modes increases design flexibility. For instance, providing architectural choices for applications in which the coolant ion is heavier than the qubit ion.

Compared with existing techniques, the cooling method of the disclosure does not exchange the motional state between any modes. Instead, the well of the Coulomb crystal is controlled to mix the characteristics between a fast-cooling mode and a slow-cooling mode and then cool both modes simultaneously. It can be used to cool both axial and radial modes.

By mixing a fast-cooling and a slow-cooling mode, two modes are obtained which cool approximately half as fast as the fast-cooling mode. For reference slow-cooling modes may cool about 1000 times slower than fast-cooling modes. The proposed cooling technique is therefore a significant improvement for purposes of quantum computing.

The ion trap system and method of the disclosure may therefore be used as part of a quantum device such as a quantum computer or a quantum sensor. For instance the quantum device may comprise a plurality of ion traps, in which a plurality of ion traps are used to trap Coulomb crystals.

A skilled person will therefore appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A method of cooling a Coulomb crystal, the Coulomb crystal comprising a first ion and a second ion having different masses, the method comprising:
applying an electric field to the Coulomb crystal to couple a first motional mode and a second motional mode of the Coulomb crystal;
adjusting the electric field to put the first motional mode and the second motional mode in an avoided crossing; and
cooling the Coulomb crystal while the first motional mode and the second motional mode are in the avoided crossing.

2. The method as claimed in claim 1, wherein the first motional mode has a first motional frequency and the second motional mode has a second motional frequency, and wherein the step of adjusting the electric field is performed at a rate that is slower than a frequency difference between the first motional frequency and the second motional frequency.

3. The method as claimed in claim 1, wherein in the avoided crossing the first motional mode and the second motional mode are adiabatically mixed.

4. The method as claimed in claim 1, wherein cooling the Coulomb crystal in the avoided crossing does not induce a transition between the first motional mode and the second motional mode.

5. The method as claimed in claim 1, wherein when cooling the Coulomb crystal in the avoided crossing, the first motional mode and the second motional mode cool down at substantially the same rate.

6. The method as claimed in claim 1, wherein the electric field is a radial electric field.

7. The method as claimed in claim 1, wherein the first motional mode is an axial mode, and the second motional mode is a radial mode.

8. The method as claimed in claim 1, wherein the first ion and the second ion are selected from different ion species to form a mixed-species Coulomb crystal.

9. The method as claimed in claim 1, wherein the first ion is a coolant ion for cooling the Coulomb crystal, and the second ion is a qubit ion for forming a qubit.

10. The method as claimed in claim 9, wherein the coolant ion is heavier than the qubit ion.

11. The method as claimed in claim 1, wherein the step of cooling the Coulomb crystal is performed using a laser cooling technique.

12. The method as claimed in claim 1, further comprising:
performing a spectroscopy measurement to check that the Coulomb crystal is in the avoided crossing.

13. An ion trap system comprising an ion trap coupled to a controller configured to perform the method of claim 1.

14. The ion trap system as claimed in claim 13, wherein the ion trap comprises a plurality of DC electrodes and at least one drive electrode, the ion trap system further comprising a voltage source coupled to the DC electrodes; a signal generator coupled to the said at least one drive electrode; wherein the controller is configured to vary the voltage at the DC electrodes to apply and adjust the electric field.

15. The ion trap system as claimed in claim 13, further comprising a laser system and a photon detector, and where in the controller is configured to control the laser system to perform a laser cooling technique.

16. A quantum device comprising the ion trap system of claim 13.
